(19) United States
(12) Patent Application Publication
(10) Pub. No.: US 2016/0327008 A1
(43) Pub. Date: Nov. 10, 2016

(54) HIGH-ENERGY IGNITION COIL

(71) Applicant: UNITED AUTOMOTIVE ELECTRONIC SYSTEMS CO. LTD, Shanghai (CN)

(72) Inventors: Yichun MAO, Shanghai (CN); Xiaoqing SUN, Shanghai (CN); Yuqiang LI, Shanghai (CN); Jie CHENG, Shanghai (CN)

(73) Assignee: UNITED AUTOMOTIVE ELECTRONIC SYSTEMS CO. LTD, Shanghai (CN)

(21) Appl. No.: 15/109,203

(22) PCT Filed: Mar. 27, 2014
(86) PCT No.: PCT/CN2014/074208

§ 371 Date: Jun. 30, 2016

(30) Foreign Application Priority Data
Dec. 31, 2013 (CN) 201310752870.X

(51) Int. Cl. F02P 3/08; H01T 15/00; H01F 38/12

(52) U.S. Cl. CPC F02P 3/0807; H01F 38/12; H01T 15/00; F02P 3/0876

(57) ABSTRACT

A high-energy ignition coil, wherein a primary coil and a secondary coil are both wound around an iron core, these three constituting a transformer. The primary coil loop is provided with a switch controlled by an ECU. The spark plug is connected at one electrode to an end of the secondary coil, and is grounded at the other electrode. An on-board power supply supplies power to the primary coil via a DC booster, which boosts the DC voltage outputted by the on-board power supply before outputting. The other end of the secondary coil is either connected to the DC booster or grounded via a reversely connected diode. A current keeping device is connected in parallel with a serial branch of the secondary coil and the spark plug, working after the spark plug is turned on to keep the spark plug on.

### FIELD OF THE INVENTION

This application relates to an ignition coil used in a vehicle with an internal combustion engine.

### BACKGROUND OF THE INVENTION

FIG. 1a shows an existing ignition coil. An on-board power supply 1, used for supplying power to a primary coil 21, is usually a low-voltage DC power supply at a rated voltage of 8-16 V. The on-board power supply 1 and the primary coil 2 constitute a primary coil loop, in which is provided a switch 3 controlled by an ECU (Electronic Control Unit). A secondary coil 22 is grounded at one end, and is connected at the other end to one electrode of a spark plug 4, with the other electrode of the spark plug 4 grounded. The secondary coil 22 and the spark plug 4 constitute a secondary coil loop. The primary coil 21 and the secondary coil 22 are both wound around an iron core 23, these three constituting a transformer 2.

The ignition coil shown in FIG. 1a may be also modified as shown in FIG. 1b, wherein the secondary coil 22 is connected at one end to the on-board power supply 1, and is connected at the other end to one electrode of the spark plug 4, with the other electrode of the spark plug 4 grounded. The on-board power supply 1, the secondary coil 22 and the spark plug 4 constitute the secondary coil loop.

The ignition coil is controlled by the ECU. In operation, the ECU drives the switch 3 to be closed, and thus the on-board power supply 1 switches on the primary coil 21. Here a current flowing through the primary coil (i.e., the primary current) will increase from 0 to a stable value, which is determined by the voltage value of the on-board power supply 1 and the resistance value of the primary coil 21. With the increase of the primary current, the electromagnetic energy generated by the primary coil 21 is stored in the iron core 23. When the primary current reaches a certain value (≦the stable value), the ECU drives the switch 3 to be instantly turned off, and then the abrupt change of the electric field of the primary coil loop causes quick attenuation of the magnetic field of the primary coil 21, thus a high-voltage electromotive force is induced on both ends of the secondary coil 22. This high-voltage electromotive force breaks down the gap between the two electrodes of the spark plug 4 (referred to as the spark plug 4 being turned on), thus generating an arc for ignition.

When an existing ignition coil works, a high-voltage electromotive force is induced on both ends of the secondary coil 22, and thus the discharge energy in the secondary coil loop (referred to as the ignition energy) is generally 30-40 mJ. With the wide application of the cylinder direct injection and turbocharging technology to the vehicle with an internal combustion engine, the energy needed by the ignition coil has reached 90 mJ, and 110 mJ for some high-end products. The existing ignition coil cannot provide so much energy. In order to enhance the ignition energy, the existing ignition coil is typically improved in three aspects, extending charging time of the primary coil, optimizing design of the magnetic circuit, and changing structure of the magnetic core.

### SUMMARY

A technical problem to be solved by this application is to provide a high-energy ignition coil that, instead of using a conventional energy-enhancing means, directly regulates the on-time of the spark plug (i.e., the time of duration when the gap between the two electrodes of the spark plug is broken down), thus enhancing the ignition energy of the ignition coil.

In order to solve the above technical problem, this application provides the following high-energy ignition coil: A primary coil and a secondary coil are both wound around an iron core, these three constituting a transformer; the primary coil loop is provided with a switch controlled by an ECU; the spark plug is connected at one electrode to an end of the secondary coil, and is grounded at the other electrode.

An on-board power supply supplies power to the primary coil via a DC booster which boosts the DC voltage outputted by the on-board power supply before outputting; the other end of the secondary coil is either connected to the DC booster, or grounded via a reversely connected diode; a current keeping device is connected at one end to the end of the secondary coil that is not connected with the spark plug, and is grounded at the other end, working after the spark plug is turned on so as to keep the spark plug on.

The ignition coil of this application can regulate the on-time of the spark plug arbitrarily, and can thus increase the ignition energy to 400 mJ and more; besides, the ignition coil of this application uses a higher voltage to turn on the primary coil, thus improving the energy conversion efficiency.

### BRIEF DESCRIPTION OF THE DRAWINGS

FIG. 1a is a structural schematic drawing of an existing ignition coil;

FIG. 1b shows a modified structure of FIG. 1a;

FIGS. 2a-2d are structural schematic drawings of four examples of the ignition coil of this application; and

FIG. 3 is a structural schematic drawing of the current keeping device in the ignition coil of this application.

### DETAILED DESCRIPTION OF THE EMBODIMENTS

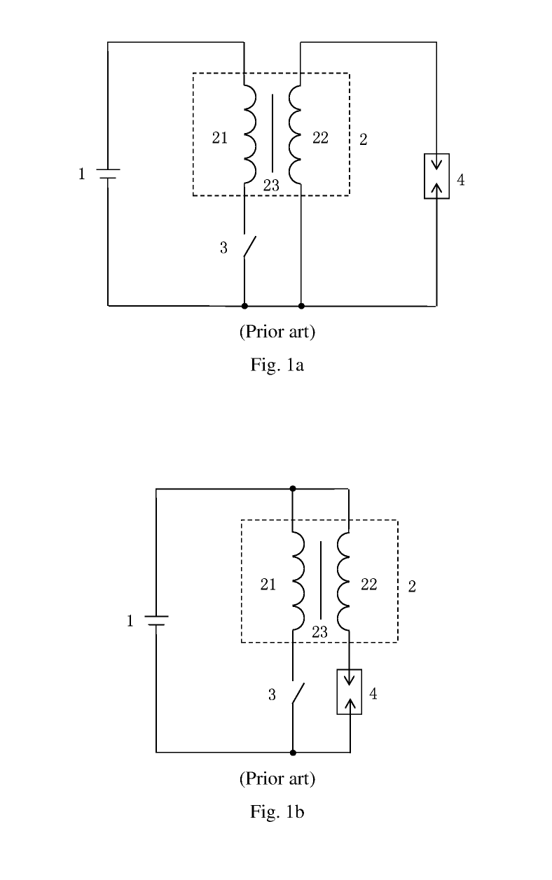

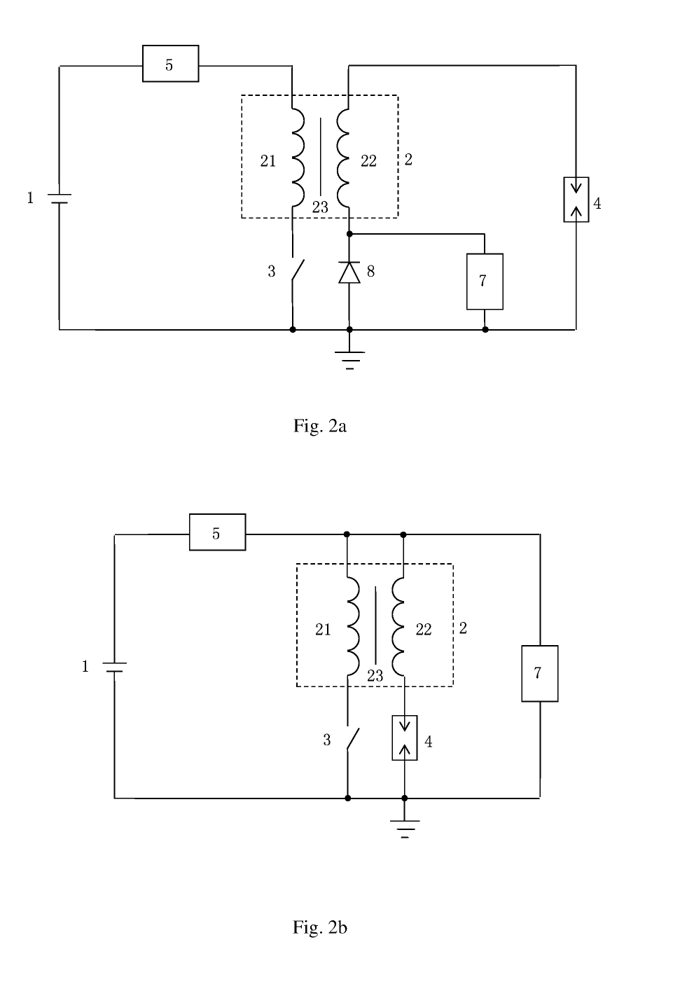

Referring to FIGS. 1a and 1b, the ignition energy value of the ignition coil is Q−∫₀^{T}(u_{ISK-OUT}×I_{OUT})dt. Wherein T is the discharge time of the secondary coil 22 in the secondary coil loop, U_{ISK-OUT} is the value of the voltage drop on the ground of an end of the secondary coil 22 that is connected to the spark plug 4, and i_{OUT} is the value of the current flowing through the secondary coil (i.e., the secondary current).

In the high-energy ignition coil of this application, discharge of the secondary coil 22 in the secondary coil loop can be divided into two stages: in the first stage, the energy of the primary coil 21 is coupled to the secondary coil 22 to make the spark plug 4 turned on; the first stage is from time 0 to time T1 for a duration of T1. In the second stage, the energy provided by the current keeping device 7 makes the spark plug 4 turned on; the second stage is from time T1 to time T1+T for a duration of T2. T=T1+T2. Therefore, the ignition energy value of the high-energy ignition coil of this application is Q=Q₁+Q₂=∫₀^{T1}(u_{ISK-OUT}×I_{OUT})dt+∫₀^{T2}(U_{ISK}×I_{ISK})dt. Wherein Q₁ represents the discharge energy value of the secondary coil 22 in the first stage, Q₂ represents the discharge energy value of the secondary coil 22 in the second stage, U_{ISK} represents the value of the voltage drop on the ground of an end of the secondary coil 22 that is connected to the spark plug 4, and I_{ISK} represents the value of the secondary current when the spark plug 4 is turned on.

In the existing ignition coil, T=T1, and T2=0. Its ignition energy Q is determined by Q₁, i.e., determined by the value of the instantaneous primary current I_{P} of the switch 3 at the moment it is turned off.

The principle of enhancing the ignition energy of the ignition coil of this application is as follows: Keeping I_{ISK} unchanged or higher from time T1 to time T, so as to keep the spark plug 4 on. In this way, Q₂ can be increased by extending T2, thus finally increasing Q.

From the point of view of energy conversion, the energy loss of the ignition coil is mainly in the following three aspects: the resistance energy loss of the primary coil, the magnetic circuit loss of the electromagnetic coupling, and the resistance energy loss of the secondary coil. Referring to FIGS. 1a and 1b, the electromagnetic energy stored in the iron core 23 while the ignition coil is working is W=L×1_{P}²/2. Wherein L represents the inductance value of the primary coil loop, which is composed of the inductance value of the primary coil 21 and the inductance value of the secondary coil 22 coupled to the primary coil loop; and I_{P} represents the instantaneous primary current value at the moment the switch 3 is turned off.

The value of the transient current flowing through the primary coil is

$$i = \frac{E}{R} \times ( 1 - {e}^{- \frac{R}{t} t} ) .$$

Wherein E represents the voltage value of the on-board power supply 1, and R represents the resistance value of the primary coil 21.

The resistance energy loss value of the primary coil 21 is Q=∫₀^{K}(I²×R×t)dt. Wherein K represents the charging time of the primary coil 21, i.e., the duration when the transient primary current i is increased from 0 to I_{P}.

It can be known from the above equation that, when the instantaneous primary current I_{P} at the moment the switch 3 is turned off is given, if the charging time T of the primary coil 21 can be shortened, the resistance energy loss of the primary coil can be reduced. Increasing the voltage E of the on-board power supply 1 is to increase the charging voltage of the primary coil 21, which will effectively shorten the charging time of the primary coil 21, and finally reduce the energy loss of the resistance of the primary coil 21.

The principle of improving the energy conversion efficiency of the ignition coil of this application is as follows: A voltage greater than the voltage of the on-board power supply 1 is used to turn on the primary coil 21, which can thus shorten the charging time of the primary coil 21, and finally reduce the resistance energy loss of the primary coil 21 and improve the energy conversion efficiency of the ignition coil.

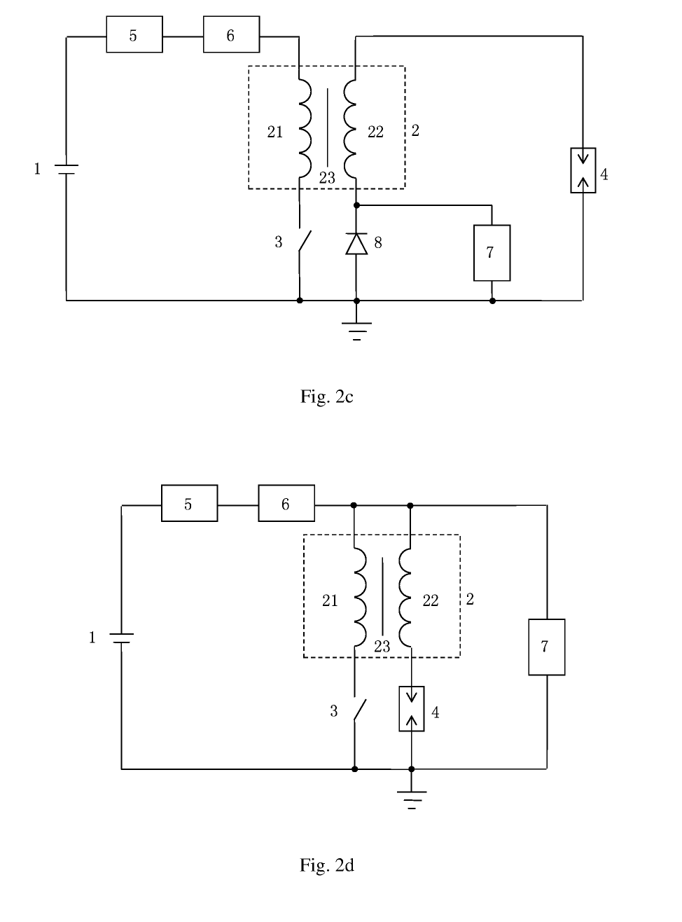

FIG. 2a shows a first example of the ignition coil of this application. An on-board power supply 1, supplying power to the primary coil 21 via a DC booster 5, is usually a low-voltage DC power supply at a rated voltage of 8-16 V. The DC booster 5 is used to boost the DC voltage outputted by the on-board power supply 1 before outputting, e.g., boosting the voltage from 16 V to 48 V before outputting. The on-board power supply 1, the DC booster 5 and the primary coil 2 constitute a primary coil loop, which is also provided with a switch 3 controlled by an ECU. The secondary coil 22 is grounded at one end via a reversely connected diode 8, and is connected at the other end to one electrode of the spark plug 4, with the other electrode of the spark plug 4 grounded. The secondary coil 22, the diode 8 and the spark plug 4 constitute a secondary coil loop. A current keeping device 7 is connected at one end to an end of the secondary coil 22 that is not connected with the spark plug 4, and is grounded at the other end. In other words, the current keeping device 7 is connected in parallel with the serial branch of the secondary coil 22 and the spark plug 4. The primary coil 21 and the secondary coil 22 are both wound around an iron core 23, these three constituting a transformer 2.

FIG. 2b shows a second example of the ignition coil of this application. It differs from the first example only in the following aspects: First, the secondary coil 22 is connected at one end to the DC booster 5, and is connected at the other end to one electrode of the spark plug 4, with the other electrode of the spark plug 4 grounded. Second, the diode 8 is omitted. Here the on-board power supply 1, the DC booster 5, the secondary coil 22 and the spark plug 4 constitute the secondary coil loop.

The work principle of the first and second examples of the ignition coil of this application is distinguished from that of the existing ignition coil in the following two aspects:

First, the output voltage of the on-board power supply 1 is boosted by the DC booster 5 before the primary coil 21 is turned on, which can thus shorten the charging time of the primary coil 21, and finally reduce energy loss of the resistance of the primary coil 21 and improve the energy conversion efficiency of the ignition coil.

Second, when the spark plug 4 is turned on, the ECU drives the current keeping device 7 to work, whose output voltage keeps the secondary current unchanged or higher, thus keeping the secondary current unchanged or higher, so as to keep the spark plug 4 on.

FIG. 2c shows a third example of the ignition coil of this application. It differs from the first example only in the following aspects: A storage battery 6 is added between the DC booster 5 and the primary coil 21, whose rated voltage is greater than that of the on-board power supply 1. For example, the rated voltage of the storage battery 6 is 48 V and the capacity is over 3 Ah. Alternatively, the storage battery 6 can also be replaced by one capacitor, or a plurality of capacitors connected in parallel. Here the on-board power supply 1, the DC booster 5, the storage battery 6 and the primary coil 2 constitute the primary coil loop.

FIG. 2d shows a fourth example of the ignition coil of this application. It differs from the third example only in the following aspects: First, the secondary coil 22 is connected at one end to the storage battery 6, and is connected at the other end to one electrode of the spark plug 4, with the other electrode of the spark plug 4 grounded. Second, the diode 8 is omitted. Here the on-board power supply 1, the DC booster 5, the storage battery 6, the secondary coil 22 and the spark plug 4 constitute the secondary coil loop.

The third and fourth examples of the ignition coil of this application have basically the same work principle with the first and second examples, except that the DC booster 5 boosts the output voltage of the on-board power supply 1 before charging the storage battery 6, and then the storage battery 6 turns on the primary coil 21. The DC booster 5 real-timely detects the voltage of the storage battery 6. When the voltage of the storage battery 6 is less than a certain voltage threshold value (typically set to be 0.83 times the rated voltage or more), the DC booster 5 boosts the output voltage of the on-board power supply 1 before charging the storage battery 6. When the voltage of the storage battery 6 is equal to or greater than the rated voltage thereof, the DC booster 5 stops working. For example, the rated voltage of the storage battery 6 is 48 V. When the voltage of the storage battery 6 drops to 44 V, the DC booster 5 works to charge the storage battery 6. When the voltage of the storage battery 6 is greater than 54 V, the DC booster 5 stops working.

In the existing ignition coil, the secondary current is not zero only at the moment the spark plug 4 is turned on. In the ignition coil of this application, the current keeping device 7 can keep the secondary current not being zero for any length of time.

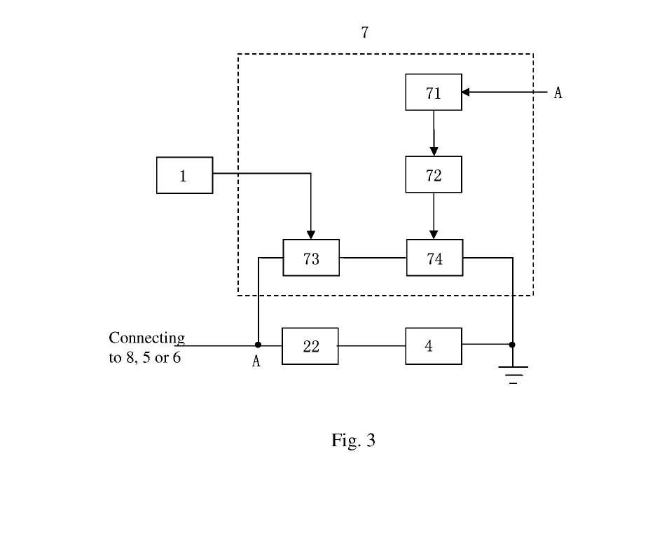

As shown in FIG. 3, the current keeping device 7 includes the following components:

A current feedback unit 71, used for collecting the secondary current value, which is preferably the current value of an end of the secondary coil 22 (Point A) not connected to the spark plug 4, and then transferring the collected secondary current value to the control unit 72.

If the secondary current value is 0, it is indicated that the spark plug 4 is turned off. If the secondary current value is not 0, it is indicated that the spark plug 4 is turned on.

A control unit 72, controlled by an ECU. The ECU transfers the on-time value of the spark plug 4 to the control unit 72. Once the control unit 72 detects that the secondary current value is less than a threshold value, it will drive the switch unit 74 to be turned on until the on-time value of the spark plug 4 specified by ECU is reached, and then the control unit 72 drives the switch unit 74 to be turned off.

If the current keeping device 7 is not applied, the variation of the secondary current value is as follows: When the spark plug 4 is turned off, the secondary current value is 0. After the spark plug 4 is turned on, the secondary current value is reduced gradually from a maximum value to 0; once the secondary current value is reduced to 0, it is indicated that the spark plug 4 is again turned off. The threshold value is set to be greater than 0 and less than or equal to the maximum value of the secondary current.

A DC boosting unit 73, used for boosting the low voltage outputted by the on-board power supply 1 to a high voltage. The DC boosting unit 73 is a DC booster that boosts, for example, 4.5-18 V to 1000 V.

A switch unit 74, controlled by a control unit 72. The switch unit 74, for example, is a triode, an MOS transistor and other switching devices. After the switch unit 74 is connected in series with the DC boosting unit 73, this serial branch is connected at one end to an end of the secondary coil 22 (Point A) that is not connected with the spark plug 4, and is grounded at the other end. In other words, this serial branch is again connected in parallel with the serial branch of the secondary coil 22 and the spark plug 4. When the switch unit 74 is turned on, the voltage outputted by the DC boosting unit 73 is transferred to both ends of the serial branch of the secondary coil 22 and the spark plug 4 to keep the secondary current unchanged or higher. When the switch unit 74 is turned off, the voltage outputted by the DC boosting unit 73 will not be transferred outward.

### INDUSTRIAL APPLICABILITY

Compared with the existing ignition coil, the ignition coil of this application can regulate the on-time of the spark plug 4 arbitrarily, and can thus increase the ignition energy, e.g., increasing the ignition energy to 400 mJ and more. In addition, the ignition coil of this application uses a DC booster 5 or a storage battery 6 having a greater voltage value than the on-board power supply 1 to turn on the primary coil 21, thus reducing the resistance energy loss of the primary coil 21 and further improving the energy conversion efficiency.

The examples above are only the preferred examples of this application, and will not limit this application. For those skilled in the art, this application can have a variety of amendment and alteration. Any amendment, equivalent replacement, improvement and so on within the spirit and principle of this application shall fall within the scope of protection of this application.

### LIST OF REFERENCE SIGNS

1. An on-board power supply; 2. a transformer; 21. a primary coil; 22. a secondary coil; 23. an iron core; 3. a switch; 4. a spark plug; 5. a DC booster; 6. a storage battery; 7. a current keeping device; 71. a current feedback unit; 72. a control unit; 73. a DC boosting unit; 74. a switch unit; and 8. a diode.

What is claimed is:

1-8. (canceled)

9. A high-energy ignition coil, wherein a primary coil and a secondary coil are both wound around an iron core, these three constituting a transformer; a primary coil loop is provided with a switch controlled by an ECU; the spark plug is connected at one electrode to an end of the secondary coil, and is grounded at the other electrode; wherein an on-board power supply supplies power to the primary coil via a DC booster, which boosts the DC voltage outputted by the on-board power supply before outputting; the other end of the secondary coil is either connected to the DC booster or grounded via a reversely connected diode; a current keeping device is connected at one end to an end of the secondary coil that is not connected with the spark plug, and is grounded at the other end, working after the spark plug is turned on to keep the spark plug on.

10. The high-energy ignition coil according to claim 9, wherein the current keeping device is connected in parallel with a serial branch of the secondary coil and the spark plug.

11. The high-energy ignition coil according to claim 9, wherein a storage battery is added between the DC booster and the primary coil, having a greater rated voltage than the on-board power supply; the on-board power supply charges the storage battery via the DC booster, and then the storage battery supplies power to the primary coil; the other end of the secondary coil is grounded or connected to the storage battery;
alternatively, the storage battery is replaced by an capacitor, or a plurality of capacitors connected in parallel.

12. The high-energy ignition coil according to claim 11, wherein when the voltage of the storage battery is less than a voltage threshold value, the DC booster boosts the output voltage of the on-board power supply before charging the storage battery; when the voltage of the storage battery is equal to or greater than the rated voltage thereof, the DC booster stops working;
the voltage threshold value is greater than or equal to 0.83 times the rated voltage thereof.

13. The high-energy ignition coil according to claim 11, wherein the rated voltage of the on-board power supply is in the range of 8-16 V, and the rated voltage of the storage battery is 48 V.

14. The high-energy ignition coil according to claim 11, wherein the capacity of the storage battery is over 3 Ah.

15. The high-energy ignition coil according to claim 9, wherein the current keeping device includes the following components:
a current feedback unit, used for collecting the secondary current value via the secondary coil, and transferring it to a control unit;
a control unit, used for receiving an on-time value of the spark plug transferred by the ECU; once the secondary current value is detected to be less than the threshold value, the control unit will drive the switch unit to be turned on, until the on-time value of the spark plug specified by the ECU is reached, and then the control unit drives the switch unit to be turned off; the threshold value is greater than 0 and less than or equal to the maximum value of the secondary current;
a DC boosting unit, used for boosting the DC voltage outputted by the on-board power supply before outputting; and
a switch unit, controlled by the control unit; the switch unit is connected in series with the DC boosting unit, which serial branch is then connected in parallel with the serial branch of the secondary coil and the spark plug; when the switch unit is turned on, the voltage outputted by the DC boosting unit is transferred to both ends of the serial branch of the secondary coil and the spark plug.

16. The high-energy ignition coil according to claim 15, wherein the current feedback unit collects the secondary current value of an end of the secondary coil that is not connected with the spark plug.
